(19) United States
(12) Patent Application Publication
(10) Pub. No.: US 2013/0055115 A1
(43) Pub. Date: Feb. 28, 2013

(54) System And Method For Implementing A User Interface To A Multi-Agent Distributed Control System

(71) Applicants: Marek Obitko, Kladno (CZ); Pavel Vrba, Vejprnice (CZ); Petr Kadera, Prague (CZ); Vaclav Jirkovsky, Praha (CZ)

(72) Inventors: Marek Obitko, Kladno (CZ); Pavel Vrba, Vejprnice (CZ); Petr Kadera, Prague (CZ); Vaclav Jirkovsky, Praha (CZ)

(21) Appl. No.: 13/595,266

(22) Filed: Aug. 27, 2012

Related U.S. Application Data
(60) Provisional application No. 61/527,659, filed on Aug. 26, 2011.

(51) Int. Cl. G06T 11/20; G09G 5/00; G06F 3/048

(52) U.S. Cl. 715/760; 345/418; 345/440; 345/672

(57) ABSTRACT

A visualization system computer communicating with a memory to execute a stored program contained in a fixed medium of the memory to display information regarding control components based on control component ontologies and knowledge bases. The visualization system includes an inspection agent configured to communicate with one or more autonomous control components of the manufacturing system to request control component information including a control component ontology including a listing of parameters and relations associated with the control component that define the operating characteristics of the control component and a knowledge base including a listing of current states for the parameters and relations of the control component. The visualization system further includes a visualization editor configured to generate a visualization interface representative of control component information received based on the request and an electronic web server configured to display the visualization interface in response to a received web page request.

### CROSS-REFERENCE TO RELATED APPLICATIONS

This application claims the benefit of U.S. Provisional Application No. 61/527,659, filed Aug. 26, 2011, and hereby incorporated by reference in its entirety.

### BACKGROUND OF THE INVENTION

The present invention relates to a user interface for an industrial control system and in particular to a system and method for implementing a user interface for a multi agent distributed control system using agent ontologies.

Industrial control systems are specialized computer systems used for the control of industrial processes or machinery, for example in a factory environment. Generally, industrial controllers or other workstations in the system execute stored control programs that read inputs from a variety of sensors associated with the controlled process and machine and, sensing the conditions of the process or machine and based on those inputs and a stored control program, calculate a set of outputs used to control actuators controlling the process or machine.

Often, the industrial control systems that are used to control the components performing the processes control a number of different systems, such as: transport device including, for example, a conveyor belt, a web of printed material, a turntable, or the like, implementation components such as a machining tool, a packing machine, inventory management system, etc. Often, a particular component will be used to perform a number of different processes each having different inputs, outputs, performed steps, etc.

Generally, the control systems have a highly modular architecture, for example, that allows different numbers and types of industrial controllers and systems to be used to perform one or more industrial and/or manufacturing processes. This modularity is facilitated through the use of distributed autonomous control agents having defined ontologies implemented in software for industrial controllers. By distributing controlled autonomous agents many advantages are gained including robustness, tolerance for defaults, implementation of more complex tasks by the whole system, more flexible control, etc. The industrial control systems may further be integrated with manufacturing execution systems to provide full control not only over the machines and material flow on the shop floor, but also with orders from customers and orders for suppliers.

Information management and visualization is especially important in an industrial control system having distributed autonomous agents. Industrial human machine interfaces provide plant, operators with means to monitor and control the processes being implemented. Human machine interfaces presenting process data to operating personnel have traditionally been designed manually as highly customized, single-purpose, user screens. The single-purpose user screens utilized specific knowledge about the manufacturing process to be displayed in the interface. However, highly customized, single purpose user interface screens do not provide the modularity that is expected in multi agent industrial control systems. For example, any modification to a controlled components operating parameters often requires redesigning of the interface based on propagated changes throughout the underlying industrial control system.

Traditional agent-based control systems exist, but tend to focus on the visualization of physical layouts and message exchanges. The visualization of control systems is usually provided with a human-machine interface connected to individual controllers. However, these systems are typically not web-based applications, require extensive customization, and are not extensible without significant reprogramming. Further, interfaces were typically either designed based on high-level function in which case they lacked detail regarding individual functionality for the autonomous agents, or were based on information from the autonomous agents and lacked information regarding high-level functionality.

What is needed is a visualization system and method configured to utilize both agent ontologies and agent knowledge bases in a production system to dynamically create a production system interface. What is further needed is such a system and method configured to allow editing using the production system interface to affect the operation one or more agents of the production system.

### SUMMARY OF THE INVENTION

The present application is directed to an industrial process visualization and control system that utilizes a combination of knowledge bases and ontologies of control components to generate an industrial process visualization. Ontologies may be used to represent all aspects of the industrial process control such a product orders, production plans, shopfloor layouts, material handling features, etc. to control the behavior of autonomous control components (agents). To complement the volume of information available using ontologies, the visualization system is configured to utilize knowledge bases to determine state information for any particular control component. The industrial process visualization may further allow direct editing of the display control components to modify the behavior the control components and directly control the industrial process.

Specifically, the present invention, in one embodiment, provides a visualization system computer communicating with a memory to execute a stored program contained in a fixed medium of the memory to display information regarding control components in a manufacturing system. The visualization system includes an inspection agent configured to communicate with one or more autonomous control components of the manufacturing system to request control component information including a control component ontology including a listing of parameters and relations associated with the control component that define the operating characteristics of the control component and a knowledge base including a listing of current states for the parameters and relations of the control component. The visualization system further includes a visualization editor configured to generate a visualization interface representative of control component information received based on the request and an electronic web server configured to display the visualization interface in response to a received web page request.

It is thus a feature of at least one embodiment of the invention to provide a visualization system where the autonomous control components include a process component representative of a production plan for producing an article in the manufacturing system.

It is thus a feature of at least one embodiment of the invention to provide a visualization system where the visualization interface is a scalable vector display graph.

It is thus a feature of at least one embodiment of the invention to provide a visualization system where the visualization interface is configured to receive input from a user modify the displayed control component information. In another embodiment, the received input to modify the displayed control component information is used to modify the control component ontology for at least one autonomous control component. Further, the operation of the autonomous control, component within the manufacturing system is changed based on the received input.

It is thus a feature of at least one embodiment of the invention to provide a visualization system where the visualization editor is configured to modify the positioning of at least a second autonomous control component in a displayed graph based on received input modifying the control component ontology for a first autonomous control component.

It is thus a feature of at least one embodiment of the invention to provide a visualization system where the knowledge base includes a shop layout for the manufacturing system.

It is thus a feature of at least one embodiment of the invention to provide a visualization system where the visualization interface is configured to display messages transmitted between the autonomous control components based on information in the received knowledge base.

It is thus a feature of at least one embodiment of the invention to provide a visualization system where the control component ontology for a first autonomous control component includes ontology information received from at least a second autonomous control component.

The present invention, in another embodiment, provides a manufacturing control system that includes a plurality of autonomous control components, each component configured to implement a manufacturing process based on a control component ontology and store information describing a current state for the manufacturing control system in a knowledge base. The system further includes a visualization interface displaying control component information for the manufacturing system based on information received from the control components including the, control component ontology and the knowledge base and an electronic web server configured to display the visualization interface in response to a received web page request.

The present invention, in yet another embodiment, provides a computer implemented visualization method implemented by a computer communicating with a memory to execute a stored program contained in a fixed medium of the memory to display information regarding control components in a manufacturing system. The method includes the step of requesting control component information from one or more autonomous control components of the manufacturing system including a control component ontology including a listing of parameters and relations associated with the control component that define the operating characteristics of the control component, and a knowledge base including a listing of current states for the parameters and relations of the control component. The method further includes the steps of generating a visualization interface representative of control component information received based on the request and transmitting a web page including the visualization interface in response to a received web page request.

These particular objects and advantages may apply to only some embodiments falling within the claims and thus do not define the scope of the invention.

### BRIEF DESCRIPTION OF THE DRAWINGS

FIG. 1 is a diagram depicting an exemplary manufacturing system including a visualization system for illustrating use of ontologies in a manufacturing agent simulation tool, according to exemplary embodiment;

FIG. 2 is a flowchart partially illustrating ontologies for a custom order, a product plan, workstations and interrelations between these ontologies, according to an exemplary embodiment;

FIG. 3 simplified perspective view of an industrial control system having a controller communicating with multiple remote motor drives over a communication network;

FIG. 4 is a block diagram of the components of the industrial control system of FIG. 3 showing multiple interacting processors of various components executing stored programs in a distributed fashion;

FIG. 5 is a flowchart illustrating a method for industrial process visualization and control that utilizes a combination of knowledge bases and ontologies of control components and processes, according to an exemplary embodiment;

FIG. 6 is a text based online visualization web page depicting ontology and knowledge base information for a manufacturing system of FIG. 1 is shown, according, to an exemplary embodiment;

FIG. 7 is a graphical online visualization web page depicting ontology and knowledge base information for a manufacturing system of FIG. 1, according to an exemplary embodiment; and

FIG. 8 is a dynamic visualization web page depicting the ontology displayed in the graph of FIG. 7 using a scalable vector graphics display graph to display only those relations selected by a user of the visualization system of FIG. 1, according to an exemplary embodiment.

### DETAILED DESCRIPTION OF THE PREFERRED EMBODIMENT

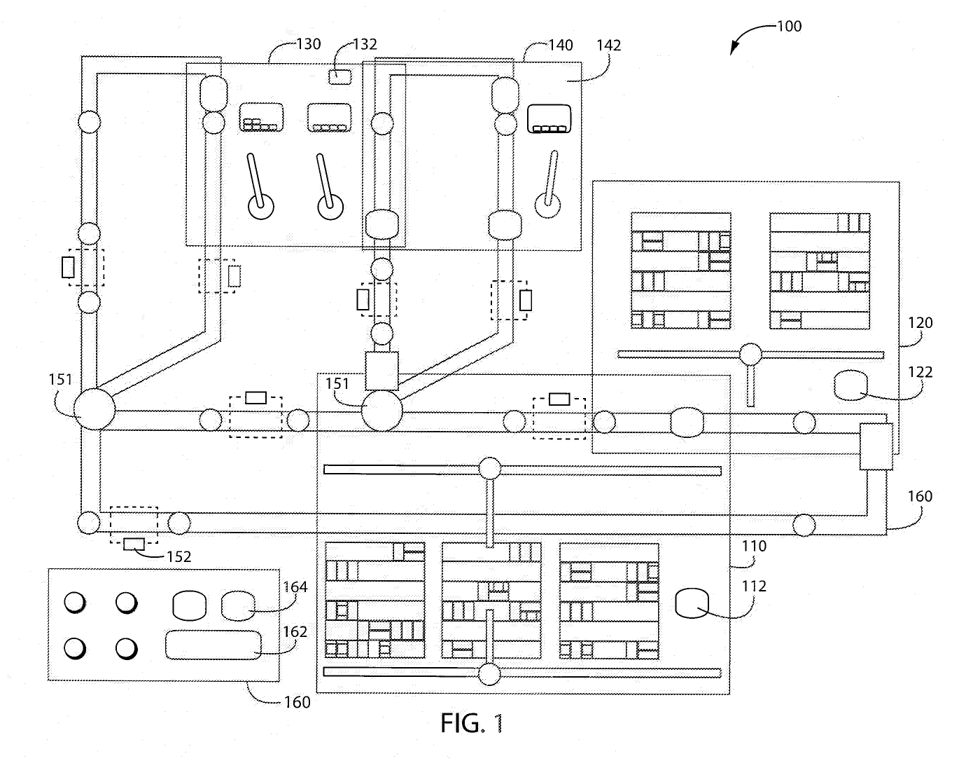

Referring now to FIG. 1, a manufacturing system 100 illustrating use of ontologies and knowledge bases received from agents in a manufacturing agent simulation tool is shown, according to exemplary embodiment. For illustrative purposes, manufacturing system 100 is depicted using exemplary manufacturing processing components for packing gift boxes based on customer orders. Manufacturing system 100 includes a first storage system workstation 110, a second storage workstation 120, a first packing process workstation 130, a second packing process workstation 140, a conveyor belt transport system 150, and a visualization system 160. According to exemplary embodiment, each component shown and described within manufacturing system 100 may be configured to be associated with an autonomous control component or agent implemented in software or hardware implemented within a workstation, industrial controller, or other hardware. Further, although system 100 is described herein with reference to a manufacturing system, it is important to recognize that the system described herein may alternatively be used for visualizing a variety of different complex systems.

Manufacturing system 100 is configured to operated using distributed autonomous control components (agents). Accordingly, each component 110-160 may include one or more associated agents. Further, agents may be associated with processes, material handling operations, resource management operations, and production plans that are not depicted in FIG. 1. Each agent is configured to operate in accordance with a defined agent ontology that provides an explicit description of functionality, relations between functionalities, restrictions on functionalities, and interoperation of functionalities. Each agent is further configured to include a knowledge base including a representation of the current state of machines and/or processes associated with a particular agent. For example, an ontology may state that there are conveyor belts and diverters with possible connections between them, while a knowledge base based on such an ontology would state that right now within manufacturing system 100 there is a diverter 151 connected to the conveyor belt 150. For example, referring to the specific example of FIG. 1, one ontology may be used to describe the physical layout of the manufacturing system 100, connection, between conveyor belts 150, diverter's, workstations, etc. Another ontology may be used to describe generic customer orders that allow customers to order products within different parameters. Yet another ontology may describe steps in a manufacturing process, including their dependency and precedents, each step including operations that are needed and the parameters of these operations.

Visualization system 160 is configured to generate a visualization interface depicting both agent ontologies and knowledge base information received from the agents within system 100 as described in further detail below. Visualization system 160 further allows information editing from within system 160. For example, it is possible that upon receipt of a description of a new type of machine which is going to be installed to introduce a new type of product and related product plan, etc., such a change is then reflected in the controls for manufacturing system 100 itself as the behavior the control components is naturally driven by the edited ontologies.

System 100 and/or components of system 100 may be implemented using one or more computer systems. Each computer system may be configured to include a processor, non-transitory memory, input and output devices such as a keyboards, a computer mouse, a display monitor, network communication channels, etc.

According to an exemplary embodiment, each component within manufacturing system 100 may be operated in accordance with autonomous control agent. Accordingly, first storage system workstation 110 includes a first storage system agent 112, second storage system workstation 120 includes a second storage system agent 122, first packing process workstation 130 includes a first packing process agent 132, second packing process workstation 140 includes a second packing process agent 142 and conveyor belt transport system 150 includes a conveyor belt agent 152. Each agent is defined to operate in accordance with a defined ontology. According to an exemplary embodiment, agents may be defined in accordance with known standards in a web ontology language (OWL). Further, agents may be configured to maintain knowledge bases expressed using a resource description framework (RDF) for syntax. Although not shown in FIG. 1, but as described in further detail below, manufacturing system 100 may be associated with a plurality of processes that are also associated with individual agents, ontologies, and knowledge bases.

Visualization system 160 is configured to include an inspector agent 162 and a Web server 164 within the visualization system 160 configured to generate a visualization interface based on ontologies and knowledge bases obtained from individual agents of the manufacturing system 100, as described in further detail below. Advantageously, a visualization system 160 configured to store information in standard knowledge bases in OWL format by removing problems based on information unavailability. Visualization system 160 is configured to visualize the information contained in the manufacturing system 100 in a uniform way by accessing information into knowledge bases and ontologies of agents.

In operation, ontologies may not be available for all of the process control components associated with manufacturing system 100. Alternatively, imported ontologies may include an extensive set of relations that are not applicable to a particular manufacturing system 100, making visualization difficult. Accordingly, visualization system 160 is configured to provide users with a selection of import options based on protection of a missing and/or extensive ontology. In a first option, visualization system 160 may be configured to exclude imports completely, i.e., filter imported ontologies out prior to initialization. This method provides the advantage of presenting a clearer visualization by removing overly extensive ontologies but also the disadvantage of making it harder to see the connection of the ontology to the rest of the system with the underlying relations. In a second option, all imports are resolved directly in the multi-agent system and all dependencies are included in a single document. The single document can then be provided using the visualization interface which means that everything is visualized even when the multi agent tool cannot access dependencies (based on their unavailability using a web-based download). In the third option, visualization system 160 may be configured to synchronize namespaces of ontologies with the Web server 164 to store the needed information. These options may be presented to a user during creation, monitoring, and/or editing of agent ontology.

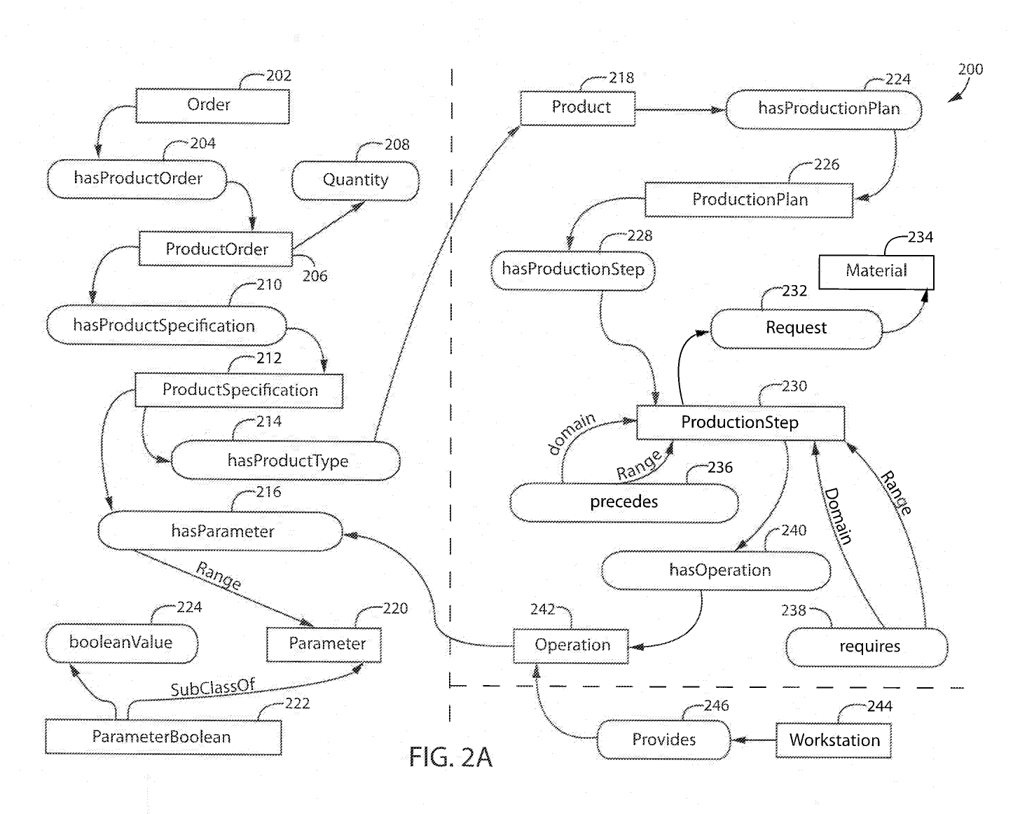

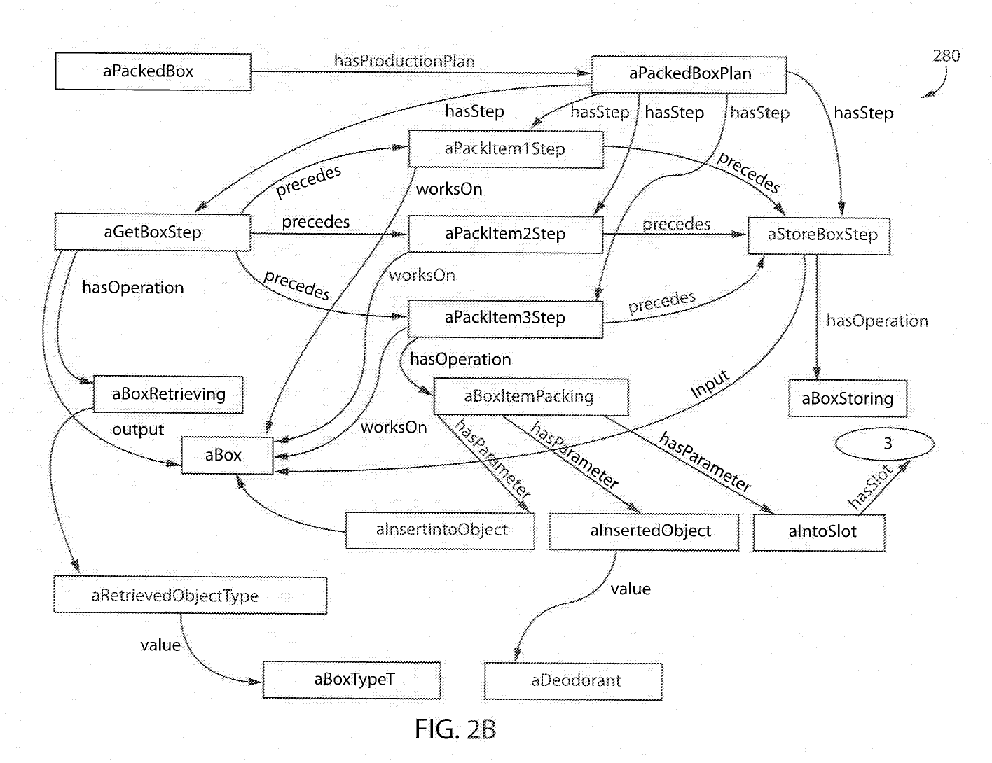

Referring now to FIG. 2, a flowchart 200 partially illustrating ontologies for a custom order, a product plan, workstations and interrelations between these ontologies is shown. Flowchart 200 depicts agent creation and operation that occurs when an order is received at manufacturing system 100. Upon receipt, an order agent 202 is created for the order that includes a hasproductorder parameter 204 that creates a product order agent 206. The, product order 206 includes a quantity parameter 208 and further hasproductspecification parameter 210 that creates a product specification agent 212. The product specification agent 212 in turn includes a hasproducttype parameter 214 that creates a product agent 218 and a generic hasparameter parameter 216 that defines a range for a parameter agent 220. Parameter agent 220 can have a defined type represented by parameter agent 220 being a subclass of a parameter Boolean agent 222 having a Boolean value parameter 224.

Product Agent 218 includes a hasproductionplan parameter 224 that creates a production plan agent 226. Production plan agent 226 in turn includes a hasproductionstep parameter 228 that creates a production step agent 230. Production step agent 230 is configured to include a plurality of parameters including a request parameter 232 requesting a material 234, a precedes parameter 236 defining both a domain and arrange, a requires parameter 238 and also defines both a domain and arrange, and a hasoperation parameter 240 creating an operation agent 242. The operation agent 242 may include the generic hasparameter parameter 216 and be configured to provide operation from a workstation 244 having an operation providing parameter 246.

Referring now to FIG. 2B, a packing plan 250 specific to the box packing operation of manufacturing system 100 is shown, according to an exemplary embodiment, for illustrative purposes. Within packing plan 250, a plurality of agents within a manufacturing system 100 are configured to pack gift boxes based on customer orders. Within packing plan 250, there are two types of gift boxes that can be filled with arbitrary combination of items. Both boxes and gift box items items are depicted as being stored in different automatic storage and retrieval systems, for example associated with workstations 110 and 120, shown in FIG. 1. Agents control the operations for finding the appropriate items, removing them from storage, and positioning the items within the gift box that then need be transported to the storage for finished boxes. All of the information, including orders, product plan, state of the products, operations and material offered by workstations, etc., are stored and communicated between agents in OWL format.

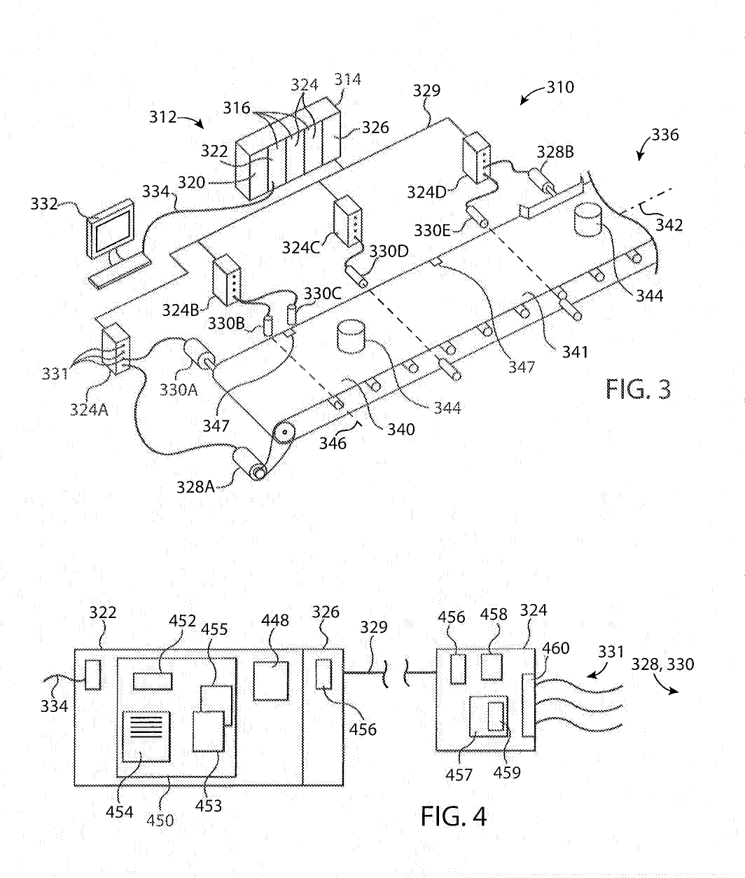

Referring now to FIG. 3, an industrial control system 310 may include an industrial controller 312 providing generally a housing 314 having an internal bus (not shown) the latter providing intercommunication between multiple modules 318 installed in the housing 314. The modules 318 may include, for example, a power supply module 320, a controller 322, one or more I/O modules 324, and a network component 326. The network component 326, or the controller 322, may communicate on an industrial control network 329 of a type providing connected messaging which provides assurances of message completion time, low latency, and lost message detection necessary for industrial control. The industrial control network 29 may be, for example, ControlNet or EtherNet/IP, well-known open standards.

The industrial control network 329 may in one embodiment join industrial controller 312 to remote I/O modules 324a-d each providing a housing supporting on its front face a series of releasable screw terminals 331 or the like for attaching the I/O module 324 via wiring to any of associated actuators 328a-b and sensors 330a-e as will be discussed below.

A configuration terminal 332 may communicate with the controller 322 and/or the remote I/O modules 324a-d over the industrial control network 329 or via a dedicated communication channel 334, for example, connecting with the controller 322. The configuration terminal 332 may be a standard desktop or laptop computer and include a keyboard, display screen, and the like to permit the entry and display of data and the operation of a configuration program by a human operator as will be described below.

Referring still to FIG. 3, the industrial control system 310 may work in conjunction with a controlled system 336 providing a moving frame 340, for example, a conveyor belt 150 having an upper surface that may move along a frame axis 342. It will be understood that the conveyor belt 150 but could be any other process component. In this example, embodiment, actuator 328a may be a motor for moving the conveyor belt 341 controlled by I/O module 324a and actuator 328b may be, for example, a pneumatic piston and associated air valve for ejecting product 344 from the surface of the conveyor belt 341 based on a signal from I/O module 324d. In this example, sensor 330a may be an optical encoder providing a position signal to the I/O module 324a indicating a relative positioning of the frame 340 with respect to an arbitrary reference line 346.

Referring now to FIG. 4, generally, the controller 322 may include a processor 448 communicating with a stored memory 450 to execute an operating system program 452 controlling the operation of the controller 322, and a control program 454 describing a desired control of the controlled system 336 (e.g. industrial machinery or process equipment), the control program 454 typically being unique to a given industrial application of the industrial control system 310. The control program 454 may be written in a variety of different languages including, for example, relay ladder language, function block language and structured text language, all well known in the art. The memory 450 may also include data tables, for example, I/O tables 453 (holding current states of signals input to and output from the I/O modules 324) and frame tables 455 (holding frame-relative positions used for triggering outputs from I/O modules 324) as used by the control program 54 and as will be described below.

Controller 322 may communicate over the backplane or an inter-processor communications bus (not shown) with the network component 326, the latter including network interface circuitry 456 providing for execution of low-level electrical protocols on the industrial control network 329. Similar network interface circuitry 456 may be provided in the I/O modules 324 to communicate with an internal processor 458 that may, for example, execute operating program 459 in memory 457. The internal processor 458 may also communicate with interface circuits 460 that may provide output signals to the actuators 328 and receive input signals from the sensors 330. The output signals to the actuators 328 may be driven by signals or instructions (for example keyed to positions or times) received from the controller 312 executing a control program 454. The input signals from sensors 330 may input variables for the control program 454 as possibly time stamped or position stamped as will be described below.

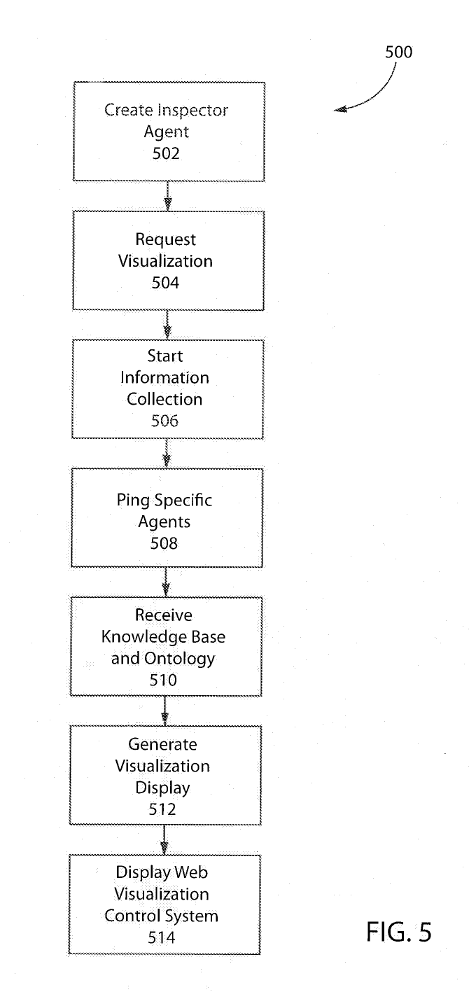

Referring now to FIG. 5, a flowchart 500 illustrating a method for industrial process visualization and control that utilizes a combination of knowledge bases and ontologies of control components and processes is shown, according to an exemplary embodiment. The method may be implemented by visualization system 160 in communication with the autonomous control agents of the manufacturing system 100. One of ordinary skill in the art would understand that the method shown in flowchart 500 may include more, fewer, and/or a different configuration steps to implement the functionality described herein.

Previously, ontology has been viewed using graph and visualization systems that depict ontology using traditional graph visualization methods. The basic ontology visualization techniques have included indented lists or tree views showing taxonomies, graphs of nodes, zoomable views useful for locating nodes, space filling that corresponds to classes as sets of instances, focus or context based positioning and filtering, and 3D views such as hyperbolic trees. Although these methods have been useful, especially for navigation in ontologies, for an operator running a control system, the visualization of knowledge bases is equally important. While the operator does not want to lose the ability to navigate hierarchies, to see the relations between entities ontology, the focus of a control system is equally on the current state of the system.

Accordingly, in a first step 502, visualization system 160 is configured to create and/or initiate an inspector agent 162. Inspector agent 162 is a software program implemented by a Web server 164 within the visualization system 160. Inspector agent 162 is configured to communicate with individual agents of the manufacturing system 100 to request their ontologies and knowledge bases. Inspector agent 162 is further configured to be able to retrieve additional information from process agents, such as plans stored in OWL format from a product plan agent 218.

In a step 504, visualization system 160 requests a visualization webpage from the web server 164 embedded in the running multi-agent manufacturing system 100. In response, web server 164 initiates information collection by inspector agent 162 in a step 506.

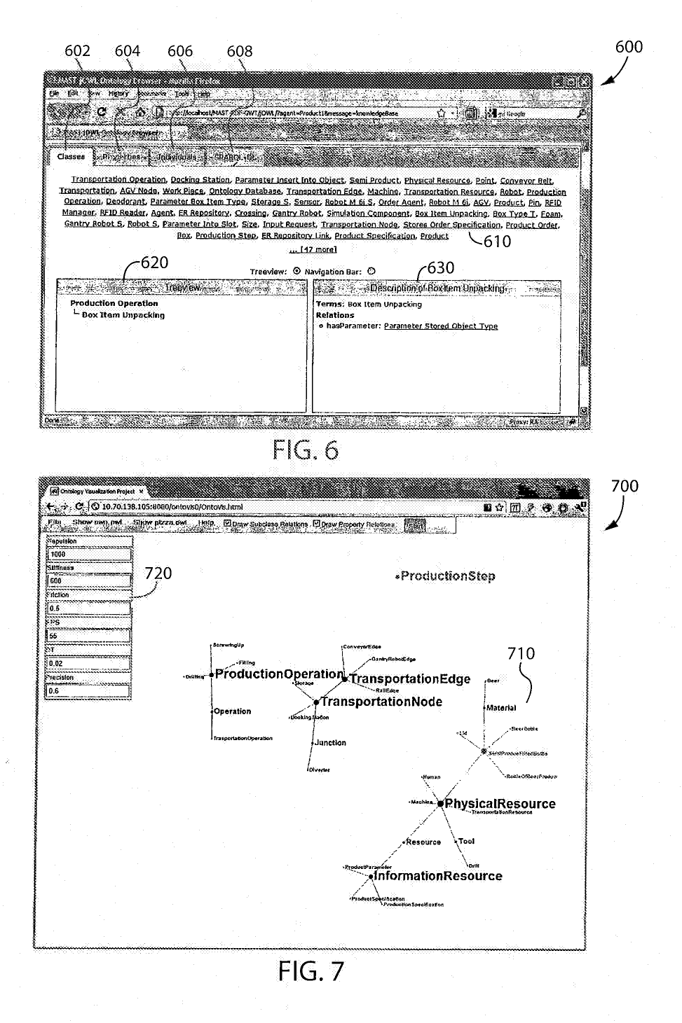

In a step 508, that is iteratively performed by the inspector agent 162, inspector agent 162 is configured to contact relevant agents, selected based on the particular visualization request, for required information. In response, in a step 510, inspector agent 162 receives a knowledge base and an ontology from the relevant agent that is used to generate a visualization display in a step 512. Visualization information is in turn published by Web server 162, as described below with reference to FIGS. 6-8, allowing display and utilization of control component information within the webpage in a step 514.

Referring now to FIG. 6, a text based online visualization web page 600 depicting ontology and knowledge base information for a manufacturing system 100 is shown, according to an exemplary embodiment. Web page 600 may be displayed by the visualization system 160 to present a visualization interface displaying detailed definition information of an ontology for a specific control or process component of a manufacturing system 100, reading comments on ontology elements, etc.

Web page 600 is a web page configured to allow simple navigation in ontologies and knowledge bases by using integrated jOWL javascript application. In operation, a user can select an ontology or knowledge base from an agent and then browse the ontology. The jOWL application allows navigation and visualization of OWL documents to view classes, properties and individuals. The jOWL application further allows querying of a loaded ontology.

Accordingly, web page 600 includes an agent class listing tab 602, an agent properties tab 604, an individual agent selection tab 606, and a SPARQ-DL tab 608. SPARQL is a query language that is able to retrieve and manipulate data stored in Resource Description Framework format for knowledge base implementations. As shown in FIG. 6, selection of class listing tab 602 displays a comprehensive listing 610 of agent classes. Selection of a particular class from class listing 610 will initiate web page 600 to display detailed class information, such as shown in FIG. 6 for the “Production Operation” agent class. Web page 600 is configured to display both a tree view 620, showing hierarchical relations associated with the “Production Operation” class, as well as detailed information 630 describing the class.

Referring now to FIG. 7, a graphical online visualization web page 6700 depicting ontology and knowledge base information for a manufacturing system 100 is shown, according to an exemplary embodiment. Web page 700 may be displayed by the visualization system 160 to provide overview information for an ontology for a specific control or process component of a manufacturing system 100 that may be associated with many relations, as opposed to the relatively simple ontology of FIG. 6.

Web page 700 is configured to display a self-organizing graph 710 that provides an overall view of a whole ontology. Web page 700 further includes a relation type filter interface 720 allowing a user to customize the kind of relations to be displayed in graph 710, such as instance of, subclass of, other relations between instances, etc.). In an iterative process, visualization system 160 is configured to display an initial random position of nodes and then analyze the provided relations to adjust the position on nodes, for example reposition near related nodes to be proximate to one another. Further, web page 700 is configured to allow manual manipulation of the nodes of graph 710, which will cause the reconfiguration of the remaining nodes based on the underlying relations.

Web page 700 may be tightly integrated with a multi-agent simulation tool allowing a user to select currently existing agents in the menus and to visualize their ontologies and the current state of their knowledge bases from a running multi agent system. Web page 700 may, for example, be used to visualize a production plan for a particular product, such as the filled gift box in the example of FIG. 1. Visualization of the production plan allows a user to see the relations between steps of the production plan and how individual parts need for each step are connected as well as connections between parameters of steps.

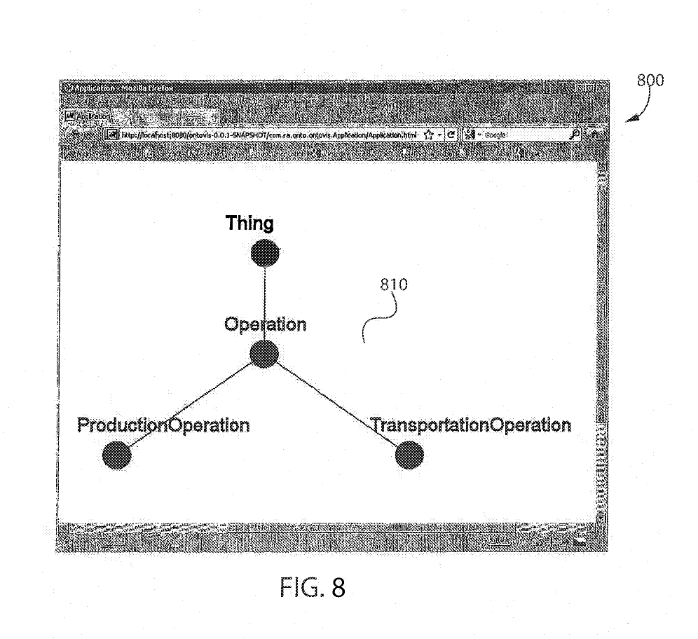

Referring now to FIG. 8, a dynamic visualization web page 800 depicting the same information as displayed in graph 710 using, a scalable vector graphics display graph 810 to display only those relations selected by a user of the system 160 is shown, according to an exemplary embodiment. Web page 800 may be displayed by the visualization system 160 based on selection of scalable viewing from the graph 710. Using the graph 810, only a portion of the hierarchy of classes in an ontology is shown. The user may selection one or more nodes to navigate down or up in the hierarchy based on relations between the classes.

Advantageously, dynamic visualization webpage 800 allows visualization system 160 to display different levels of granularity (overall system versus particular component). For example, when looking at a single component (agent), that agent's knowledge base can be retrieved and visualized again fastened site to the state of the component. If this component is for example a machine, then the user can see as planned and contractor jobs. In the case of an agent representing a product instance, the user can see the current status of the production plan, i.e., what operations were performed, which operation by the machine is currently in progress, what are the required operations and material for the following steps, etc.

In a high level, it is possible to retrieve information from a larger group of moments and easily merged together. For example, a proper visualization, privileged and material resources, plans, workstations and physical layout can be displayed and analyzed. Display graph 800 may be manipulated to scale down to the level of messages sent between the components to inspect information flow in the distributed system.

In operation, visualization system 160 is configured to start an expiration of agent ontology is with graph-based tools, as shown in FIGS. 7 and 8, to gain insights into the state of the manufacturing system 100 (plan, agent, etc.) and then, if needed switch to text based browsing to inspect details, as shown in FIG. 6. Thereafter, visualization system 160 may be configured to allow the user to edit agent ontology online, for example using a Web Protégé editor, as is known in the art. Including functionality to allow a user to edit agent ontology online allows reconfigure of a running system in real-time, for example it would be needed to add a new product a new product plan for that product.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications are hereby incorporated herein by reference in their entireties.

What is claimed is:

1. A visualization system computer communicating with a memory to execute a stored program contained in a fixed medium of the memory to display information regarding control components in a manufacturing system, comprising:
an inspection agent configured to communicate with one or more autonomous control components of the manufacturing system to request control component information including
1) a control component ontology including a listing of parameters and relations associated with the control component that define the operating characteristics of the control component, and
2) a knowledge base including a listing of current states for the parameters and relations of the control component;
a visualization editor configured to generate a visualization interface representative of control component information received based on the request; and
an electronic web server configured to display the visualization interface in response to a received web page request.

2. The visualization system of claim 1, wherein the autonomous control components include a process component representative of a production plan for producing an article in the manufacturing system.

3. The visualization system of claim 1, wherein the visualization interface is a scalable vector display graph.

4. The visualization system of claim 1, wherein the visualization interface is configured to receive input from a user modify the displayed control component information.

5. The visualization system of claim 4, wherein received input to modify the displayed control component information is used to modify the control component ontology for at least one autonomous control component.

6. The visualization system of claim 5, wherein the operation of the autonomous control component within the manufacturing system is changed based on the received input.

7. The visualization system of claim 1 wherein the visualization editor is configured to modify the positioning of at least a second autonomous control component in a displayed graph based on received input modifying the control component ontology for a first autonomous control component.

8. The visualization system of claim 1, wherein the knowledge base includes a shop layout for the manufacturing system.

9. The visualization system of claim 1, wherein the visualization interface is configured to display messages transmitted between the autonomous control components based on information in the received knowledge base.

10. The visualization system of claim 1, wherein the control component ontology for a first autonomous control component includes ontology information received from at least a second autonomous control component.

11. A manufacturing control system, comprising:
a plurality of autonomous control components, each component configured to
implement a manufacturing process based on a control component ontology, and
store information describing a current state for the manufacturing control system in a knowledge base;
a visualization interface displaying control component information for the manufacturing system based on information received from the control components including the control component ontology and the knowledge base; and
an electronic web server configured to display the visualization interface in response to a received web page request.

12. A computer implemented visualization method implemented by a computer communicating with a memory to execute a stored program contained in a fixed medium of the memory to display information regarding control components in a manufacturing system, the method comprising:
requesting control component information from one or more autonomous control components of the manufacturing system including
1) a control component ontology including a listing of parameters and relations associated with the control component that define the operating characteristics of the control component, and
2) a knowledge base including a listing of current states for the parameters and relations of the control component;
generating a visualization interface representative of control component information received based on the request; and
transmitting a web page including the visualization interface in response to a received web page request.

13. The visualization method of claim 12, wherein the autonomous control components include a process component representative of a production plan for producing an article in the manufacturing system.

14. The visualization method of claim 12, wherein the visualization interface is a scalable vector display graph.

15. The visualization method of claim 12, wherein the visualization interface is configured to receive input from a user modify the displayed control component information.

16. The visualization method of claim 15, wherein received input to modify the displayed control component information is used to modify the control component ontology for at least one autonomous control component.

17. The visualization method of claim 16, wherein the operation of the autonomous control component within the manufacturing system is changed based on the received input.

18. The visualization method of claim 12, wherein the visualization editor is configured to modify the positioning of at least a second autonomous control component in a displayed graph based on received input modifying the control component ontology for a first autonomous control component.

19. The visualization method of claim 12, wherein the visualization interface is configured to display messages transmitted between the autonomous control components based on information in the received knowledge base.

20. The visualization method of claim 12, wherein the control component ontology for a first autonomous control component includes ontology information received from at least a second autonomous control component.
